(19) United States
(12) Patent Application Publication
(10) Pub. No.: US 2025/0369583 A1
(43) Pub. Date: Dec. 4, 2025

(54) MODULAR CUT-OFF SHIELD FOR HEADLIGHTS

(71) Applicant: Autosystems, a division of Magna Exteriors Inc., Aurora (CA)

(72) Inventors: Garrick Tsui, Ann Arbor, MI (US); Tomáš Janácek, Radun (CZ); James Spalding, Dearborn Heights, MI (US)

(21) Appl. No.: 19/225,373

(22) Filed: Jun. 2, 2025

Related U.S. Application Data
(60) Provisional application No. 63/655,386, filed on Jun. 3, 2024.
(60) Provisional application No. 63/773,030, filed on Mar. 17, 2025.

(51) Int. Cl. F21S 41/43; F21S 41/20; F21W 102/135

(52) U.S. Cl. CPC F21S 41/43; F21S 41/20; F21W 2102/135

(57) ABSTRACT

A lighting module for a headlight in a vehicle includes: a projector light source; a second light source associated with a low-beam function; a lens defining a first lens portion and a second lens portion each associated with a corresponding one of the light sources; a housing holding the light sources and holding the lens at a fixed position relative to the light sources and spaced apart therefrom; and a shield assembly disposed in an interior of the housing between the light sources and the lens. The shield assembly includes a light blocker configured to block light from the projector light source from reaching the second lens portion and to block light from the second light source from reaching the first lens portion. The shield assembly also includes a cut-off portion configured to interrupt a portion of light emitted from the second light source and to define a cut-off pattern.

### CROSS REFERENCE TO RELATED APPLICATIONS

This U.S. utility patent application claims the benefit of U.S. Provisional Patent Application No. 63/655,386, filed Jun. 3, 2024, and U.S. Provisional Patent Application No. 63/773,030 filed Mar. 17, 2025, the contents of which are incorporated herein by reference in their entirety.

### FIELD

The present disclosure relates generally to lighting for motor vehicles. More specifically, the present disclosure relates to headlights for passenger vehicles, such as cars and trucks.

### BACKGROUND

Headlight assemblies for vehicles are subject to regulations regarding a cut-off pattern in order to illuminate a roadway ahead of the vehicle while also minimizing disruption to drivers of other vehicles, including oncoming traffic and vehicles traveling ahead of and in a same direction as the subject vehicle. Several different regulations and standards for headlight illumination may apply in different jurisdictions. Examples of such regulations and standards include ECE Created by the United Nations Economic Commission for Europe, United States Department of Transportation (DOT) for use in the U.S. & Canada, CCC certification for China, and U.S. Society of Automotive Engineers (SAE) standards.

Headlight Assemblies may include one or more lighting modules each configured to provide a specific illumination pattern. There is a demand for lighting modules with ever smaller sizes and in various different layout configurations to provide stylish arrangements that also meet regulatory and manufacturer requirements for light output.

### SUMMARY

The present disclosure provides a lighting module for a headlight in a vehicle. The lighting module includes: a projector light source; a second light source associated with a low-beam function; a lens defining a first lens portion associated with the projector light source and a second lens portion associated with the second light source; a housing holding the projector light source and the second light source and holding the lens at a fixed position relative to the projector light source and the second light source and spaced apart therefrom; and a shield assembly disposed in an interior of the housing between the light sources and the lens. The shield assembly includes a light blocker configured to block light from the projector light source from reaching the second lens portion and to block light from the second light source from reaching the first lens portion. The shield assembly also includes a cut-off portion configured to interrupt a portion of light emitted from the second light source and to define a cut-off pattern.

The present disclosure provides a lighting module for a headlight in a vehicle. The lighting module includes: a projector light source; a second light source associated with a low-beam function; a lens defining a first lens portion associated with the first light source and a second lens portion associated with the second light source; and a housing holding the projector light source and the second light source and holding the lens at a fixed position relative to the projector light source and the second light source and spaced apart therefrom. The housing further defines a hole and one or more retaining tabs configured to hold the lens against an interior surface of the housing and in a fixed position extending through the hole.

The present disclosure also provides a headlight assembly for a vehicle. The headlight assembly includes two lighting modules. Each of the two lighting modules includes: a projector light source a second light source associated with a low-beam function; a lens defining a first lens portion associated with the projector light source and a second lens portion associated with the second light source; a housing holding the projector light source and the second light source and holding the lens at a fixed position relative to the projector light source and the second light source and spaced apart therefrom; and a shield assembly disposed in an interior of the housing between the light sources and the lens. The shield assembly includes a light blocker configured to block light from the projector light source from reaching the second lens portion and to block light from the second light source from reaching the first lens portion. The shield assembly also includes a cut-off portion configured to interrupt a portion of light emitted from the second light source and to define a cut-off pattern. The projector light source of one of the two lighting modules is associated with the low-beam function, and the projector light source of another one of the two lighting modules is associated with a high-beam function.

The present disclosure also provides a lighting system for a vehicle, including: two headlight assemblies, with each of the headlight assemblies including at least one lighting module. Each lighting module of the at least one lighting module includes: a projector light source a second light source associated with a low-beam function; a lens defining a first lens portion associated with the projector light source and a second lens portion associated with the second light source; a housing holding the projector light source and the second light source and holding the lens at a fixed position relative to the projector light source and the second light source and spaced apart therefrom; and a shield assembly disposed in an interior of the housing between the light sources and the lens. The shield assembly includes a light blocker configured to block light from the projector light source from reaching the second lens portion and to block light from the second light source from reaching the first lens portion. The shield assembly also includes a cut-off portion configured to interrupt a portion of light emitted from the second light source and to define a cut-off pattern.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings.

FIG. 1 shows a schematic block diagram of a vehicle with two first headlight assemblies, in accordance with the present disclosure.

FIG. 2 shows a perspective view of a dual-projector lighting module for a headlight assembly, in accordance with the present disclosure.

FIG. 3 shows a cutaway view of the dual-projector lighting module of FIG. 4.

FIG. 4 shows a front perspective view of internal components of the dual-projector lighting module of FIG. 2.

FIG. 5 shows a front view of a printed circuit board (PCB) of the first dual-projector lighting module, in accordance with the present disclosure.

FIG. 6 shows a front view of a printed circuit board (PCB) of the second dual-projector lighting module, in accordance with the present disclosure.

FIG. 7 shows a top view of a first shield assembly for the dual-projector lighting module of FIG. 2 and in a flat configuration.

FIG. 8 shows the first shield assembly of FIG. 7 in a bended configuration for installation in a lighting module.

FIGS. 9-10 each show a cutaway side view of the dual-projector lighting module of FIG. 2 and illustrating illumination patterns produced thereby.

FIG. 11 shows a cutaway side view of the dual-projector lighting module of FIG. 2 and illustrating an illumination pattern produced by a second light source and inverted by the lens.

FIG. 12 shows a cutaway side view of the dual-projector lighting module of FIG. 2 and illustrating an illumination pattern produced by a second light source and as impacted by a reflective finish on an upper surface of the shield.

FIGS. 13A-13B show a second shield assembly having a contoured terminal edge to generate a specific cut-off pattern.

FIG. 14 shows a low beam illumination pattern with the specific cut-off pattern generated by the second shield of FIGS. 13A-13B.

FIGS. 15A-15C show various different cut-off patterns for different regulations and standards for headlight illumination.

FIG. 16 shows a third shield assembly for installation in a lighting module of the present disclosure.

FIG. 17 shows a fourth shield assembly for installation in a lighting module of the present disclosure.

FIG. 18 shows a partial transparent view of the two dual-projector lighting modules of the present disclosure, with the third and fourth shield assemblies.

FIGS. 19A-19B each show a front view of components in the second and first dual-projector lighting modules of the present disclosure, respectively.

FIGS. 20A-20B show top and front views of components in the first dual-projector lighting module of the present disclosure.

FIGS. 21A-21B show top and front views of components in the second dual-projector lighting module of the present disclosure.

FIG. 22 shows a schematic block diagram of a vehicle with two second headlight assemblies, in accordance with the present disclosure.

FIG. 23 shows an exploded view of a single-projector lighting module for a headlight assembly, in accordance with the present disclosure.

FIG. 24 shows a front view of a printed circuit board (PCB) of the single-projector lighting module, in accordance with the present disclosure.

FIG. 25A-25D show various views of the single-projector lighting module of FIG. 25.

FIG. 26A-26C show additional views of the single-projector lighting module of FIG. 25.

FIG. 27 shows a fourth shield assembly for the single-projector lighting module of the present disclosure.

FIGS. 28A-28B show top and front views of components in the single-projector lighting module of the present disclosure.

FIG. 29 shows a perspective view of components in the single-projector lighting module of the present disclosure.

FIG. 30 shows a front view of components in the single-projector lighting module of the present disclosure.

FIG. 31 shows the third and fourth shield assemblies of the present disclosure, with details regarding different finishes applied to surfaces thereof.

FIGS. 32A-32B show different views of a third dual-projector lighting module of the present disclosure, with a snap feature for retaining a secondary lens therein.

### DETAILED DESCRIPTION

Referring to the drawings, the present invention will be described in detail in view of following embodiments.

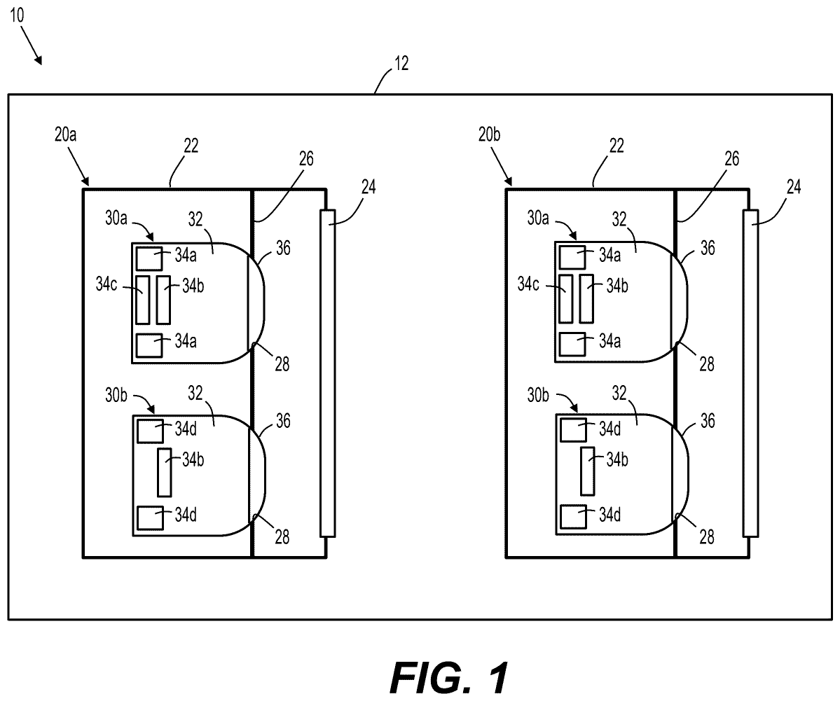

FIG. 1 shows a schematic block diagram of a vehicle 10 with a first lighting system 12, according to an aspect of the present disclosure. The vehicle 10 may be a motor vehicle, such as a passenger car or truck. However, the lighting systems of the present disclosure may be applicable to other types of vehicles, such as commercial trucks, busses, trains, etc. The vehicle 10 with the first lighting system 12 of the present disclosure may also be referred to as the ego vehicle or the subject vehicle. The first lighting system 12 includes a first left-side headlight assembly 20a and a first right-side headlight assembly 20b. Each of the first headlight assemblies 20a, 20b may be similar or identical to one-another. In some embodiments, the first headlight assemblies 20a, 20b may include similar or identical internal components and different external components, such as a first enclosure 22 that is configured to fit within the structure on the corresponding side of the vehicle 10.

As shown in FIG. 1, each of the first headlight assemblies 20a, 20b also includes a first window 24 of transparent material for emitting light and a first bezel 26 disposed within a corresponding one of the first enclosures 22. Each of the first bezels 26 defines a plurality of first openings 28.

Each of the each of the first headlight assemblies 20a, 20b also includes two dual-projector lighting modules 30a, 30b. The two dual-projector lighting modules 30a, 30b include a first dual-projector lighting module 30a, and a second dual-projector lighting module 30b, and which each provide corresponding beam patterns. Each of the two dual-projector lighting modules 30a, 30b may provide both high-beam (HB) and low-beam (LB) illumination. However, only the first dual-projector lighting module 30a may provide a low-beam spread beam pattern with relatively lower intensity and over a relatively large angular field of illumination, and only the second dual-projector lighting module 30b may provide a majority of a high-beam pattern. However, the principles of the present disclosure may be applied to other headlight assemblies that include fewer than or more than two lighting modules and/or lighting modules having different purposes or arrangements.

In some embodiments, and as described in the present disclosure, each of the two dual-projector lighting modules 30a, 30b includes two projector light sources 34a, 34d, a second light source 34b, each configured to produce light. The first dual-projector lighting module 30a also includes a third light source 34c which is also configured to produce light. Each of the light sources 34a, 34b, 34c, 34d may include one or more light emitting diodes (LEDs) disposed on a substrate, such as a printed circuit board. However, the light sources 34a, 34b, 34c, 34d may include other types of illumination sources, such as LED arrays, organic LEDs (OLEDs) halogen bulbs, high-intensity discharge (HID) lamps, lasers, etc. The two projector light sources 34a, 34d may be located on outboard sides of the dual-projector lighting modules 30a, 30b, with the second light source 34b and the third light source 34c located between the two projector light sources 34a, 34d. The second light source 34b may be located directly above the third light source 34c.

The second light sources 34b may be associated with a low-beam function, and the third light sources 34c may be associated with a high-beam function. The projector light sources 34a, 34d may include low-beam projector light sources 34a that are associated with the low-beam function, and high-beam projector light sources 34d that are associated with the high-beam function. As shown, the first dual-projector lighting module 30a includes two of the low-beam projector light sources 34a, and the second dual-projector lighting module 30b includes two of the high-beam projector light sources 34d. However, the two dual-projector lighting modules 30a, 30b may have a different configuration. For example, each of the two dual-projector lighting modules 30a, 30b may include one of the low-beam projector light sources 34a and one of the high-beam projector light sources 34d.

Each of the two dual-projector lighting modules 30a, 30b also includes a first secondary lens 36, for focusing and directing light emitted by the corresponding light sources 34a, 34b, 34c, 34d. The first secondary lens 36 may be made of polycarbonate (PC) or Poly(methyl methacrylate) (PMMA). However, the first secondary lens 36 may include one or more other materials. In some embodiments, and as shown in FIG. 1, the first secondary lenses 36 may each protrude through a corresponding one of the first openings 28 in the first bezels 26. Each of the two dual-projector lighting modules 30a, 30b also includes a first housing 32. The first housings 32 may be made of a high-temperature polycarbonate (PC-HT) material or a standard temperature (not high-temperature) polycarbonate (PC) material. However, the first housings 32 may include one or more other materials. The first housings 32 each hold the corresponding light sources 34a, 34b, 34c, 34d and the corresponding first secondary lens 36, with the first secondary lens 36 at a fixed position relative to the light sources 34a, 34b, 34c, 34d and spaced apart therefrom.

The two dual-projector lighting modules 30a, 30b may be arranged in the first headlight assemblies 20a, 20b with an in-line arrangement, in a horizontal line. However, the dual-projector lighting modules 30a, 30b may be arranged in a vertical-stacked configuration or in any other arrangement. Each of the two dual-projector lighting modules 30a, 30b have first secondary lenses 36 that are generally rectangular, as viewed head-on. The first secondary lenses 36 may have a relatively thin profile. For example, in some embodiments, the first secondary lenses 36 may each have a height of about 15 mm and a width of about 45 mm.

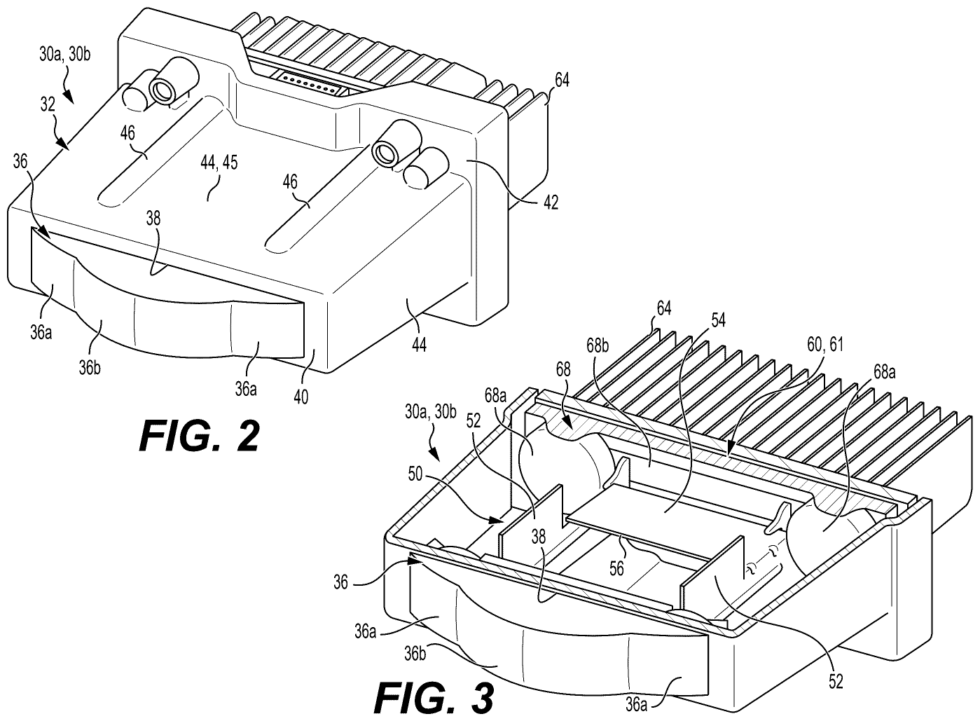

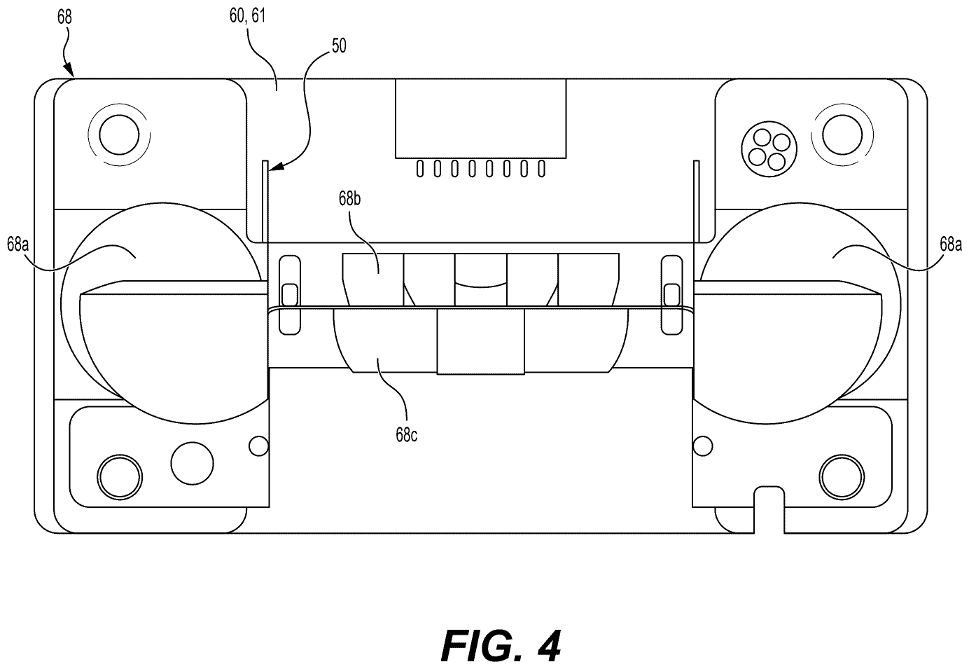

FIGS. 2-4 each show one of the dual-projector lighting modules 30a, 30b. The first housings 32 of the dual-projector lighting modules 30a, 30b each have a tubular shape with a generally rectangular cross-section and which extends between a first end 40 and a second end 42. The first secondary lenses 36 are each disposed within a corresponding one of the first housings 32 and adjacent to the first end 40. The first end 40 defines a first aperture 38 having a rectangular shape. The first secondary lenses 36 each protrude through a corresponding one of the first apertures 38. The light sources 34 are attached to each of the first housings 32 and adjacent to the second end 42. In some embodiments, and as shown on FIG. 2, the first housings 32 include a mounting flange at the second end 42 for mounting the first housing 32 within the corresponding headlight assembly 20a, 20b. Each of the first housings 32 include several outer surfaces 44 including an upper surface 45. The upper surfaces 45 each define two linear protrusions 46 that correspond to slots on an interior surface for receiving a corresponding first light blocker 52 and thereby holding a first shield assembly 50 in a fixed position within an interior of the first housing 32, between the light sources 34a, 34b, 34c, 34d and the first secondary lens 36.

In some embodiments, the tubular shape of each of the first housings 32 defines an interior having a substantially constant cross-section substantially an entire length between the first end 40 and the second end 42. Alternatively or additionally, the tubular shapes of one or more of the first housings 32 may define a taper with a progressive narrowing in width and/or height from the second end 42 toward the first end. This substantially constant cross-section or tapering may allow the first secondary lenses 36 to be slid into position through an opening at the second end 42 and for securement within the first housing 32 adjacent to the first end 40. As shown, the dual-projector lighting modules 30a, 30b each include a printed circuit board (PCB) 60, 61.

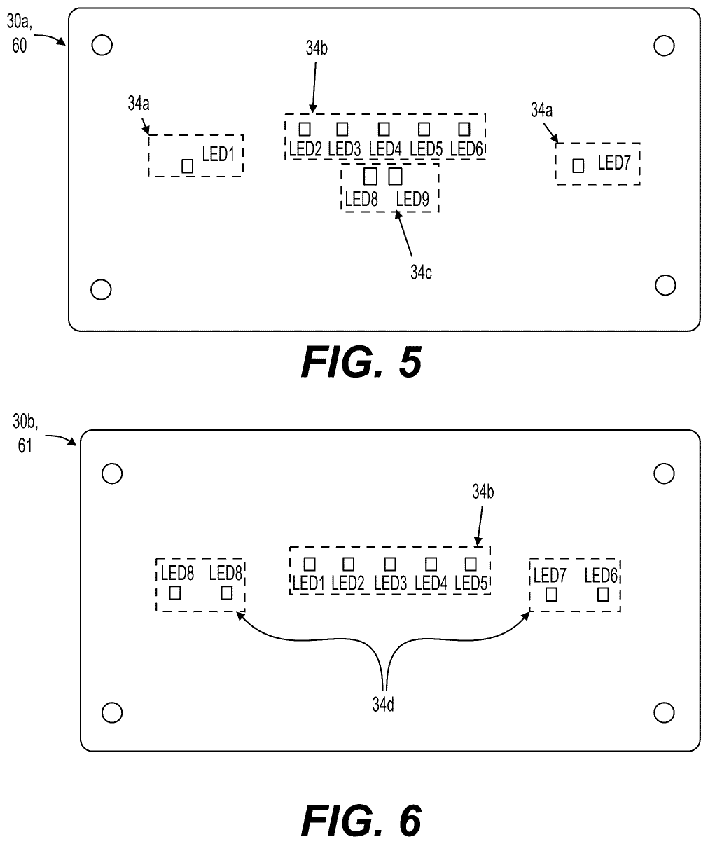

FIG. 5 shows a front view of a first printed circuit board (PCB) 60 of the first dual-projector lighting module 30a, and FIG. 6 shows a front view of a second PCB 61 of the second dual-projector lighting module 60b. Each of the PCBs 60, 61 holds a plurality of light generating devices, such as LEDs to implement the the light sources 34a, 34b, 34c, 34d. Referring back to FIG. 3, a first heat sink 64 is attached to a rear surface of each of PCBs 60, 61, opposite from the LEDs.

The first secondary lens 36 includes two first lens portions 36a disposed on either side of a second lens portion 36b. The two first lens portions 36a may each be aligned with and configured to focus and direct light from a corresponding one of the low-beam projector light sources 34a or the high-beam projector light sources 34d. The second lens portion 36b may be aligned with and configured to focus and direct light from both of the second light source 34b and the third light source 34c.

The second lens portion 36b may function to invert the illumination patterns from each of the second light source 34b and the third light source 34c. The first dual-projector lighting module 30a and the second dual-projector lighting module 30b are each configured to produce low-beam lighting patterns of illumination below a corresponding cut-off line. Because of the inverting function of the first secondary lenses 36, the first shield assembly 50 of the first dual-projector lighting module 30a and the second dual-projector lighting module 30b may each define a first cut-off portion 54 below the second light source 34b and configured to produce the corresponding low-beam lighting patterns with patterns of illumination below corresponding cut-off lines.

The third light source 34c may be disposed below the first cut-off portion 54, opposite from the second light source 34b. That is, the first cut-off portion 54 may separate light produced by each of the second light source 34b and the third light source 34c.

A first primary lens assembly 68 is disposed over the light sources 34a, 34b, 34c, 34d, between the light sources 34a, 34b, 34c, 34d, and the first secondary lens 36. The first primary lens assembly 68 may be made of polycarbonate (PC) or Polymethacrylmethylimide (PMMI). However, the first primary lens assembly 68 may include one or more other materials. The first primary lens assembly 68 includes two first primary optic portions 68a, second primary optic portion 68b and a third primary optic portion 68c.

The two first primary optic portions 68a are disposed on either side of the second primary optic portion 68b and a third primary optic portion 68c. The two first primary optic portions 68a may each be disposed in a first optical path between a corresponding one of the projector light sources 34a, 34d and a corresponding first lens portion 36a of the first secondary lens 36. The second primary optic portion 68b may be disposed in a second optical path between the second light source 34b and the and the second lens portion 36b of the first secondary lens 36. The third primary optic portion 68c may be disposed in a third optical path between the third light source 34c and the and the second lens portion 36b of the first secondary lens 36. The first primary optic portions 68a may each be used for a low-beam function in the first dual-projector lighting module 30a and for a high-beam function in the second dual-projector lighting module 30b. The second primary optic portion 68b may provide low beam central illumination in each of the the dual-projector lighting modules 30a, 30b, and the third primary optic portion 68c may provide high beam central illumination in each of the the dual-projector lighting modules 30a, 30b.

As shown, the first shield assembly 50 is disposed in an interior of the first housing 32 between the light sources 34a, 34b, 34c, 34d and the first secondary lens 36. The first shield assembly 50 includes two first light blockers 52, each extending in vertical plane and configured to block light from the projector light sources 34a, 34d from reaching the second lens portion 36b and to block light from the second light source 34b from reaching the first lens portions 36a. The first shield assembly 50 also includes a first cut-off portion 54 that extends in a horizontal plane and is configured to interrupt a portion of light emitted from the second light source 34b and to define a cut-off pattern. More specifically, the first cut-off portion 54 defines a first terminal edge 56 opposite from the light sources 34a, 34b, 34c, 34d and which defines the edge of the cut-off pattern.

In some embodiments, the first shield assembly 50 may be formed from a single piece of sheet metal, such as stainless steel, that is bent to define each of the first light blockers 52 and the first cut-off portion 54.

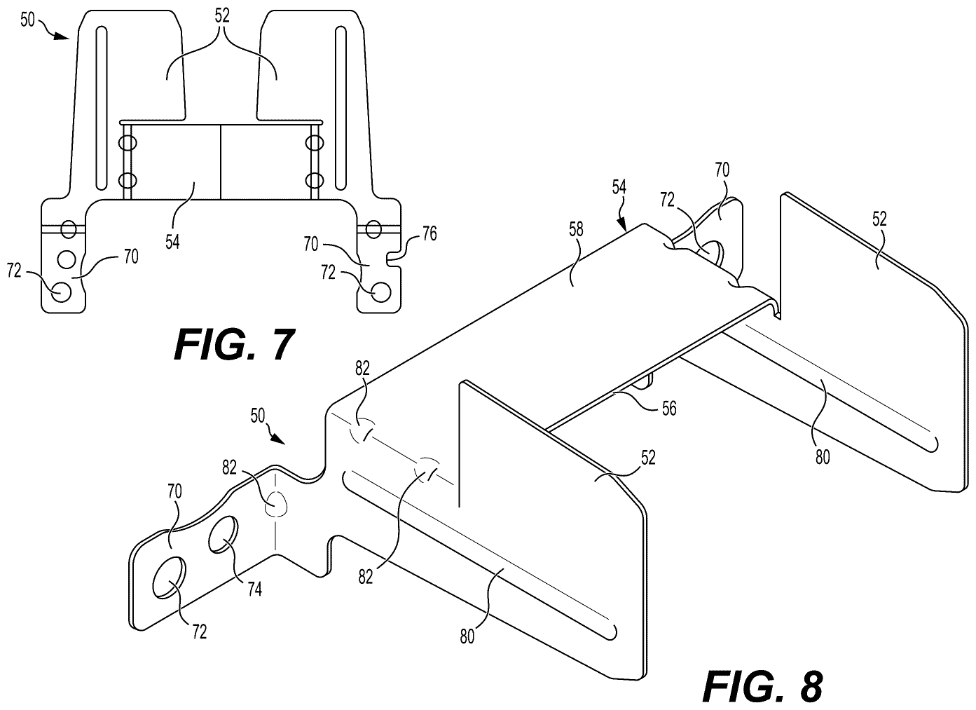

FIGS. 7-8 show the first shield assembly 50 in additional detail. FIG. 7 shows the first shield assembly 50 in a flat configuration, and FIG. 8 shows the first shield assembly 50 in a bended configuration for installation in one of the the dual-projector lighting modules 30a, 30b.

As shown, the first shield assembly 50 includes the first cut-off portion 54 extending in a horizontal plane between the two first light blockers 52, which are parallel and spaced apart from one another. The first cut-off portion 54 defines an first upper surface 58 having a reflective finish. For example, the first upper surface 58 may have a mirror-polished finish with a reflectivity of about 60%, whereas other areas of the first shield assembly 50 may have a reflectivity of about 30%. In some embodiments, the first upper surface 58 of the first cut-off portion 54 includes a metalized coating. The metalized coating may be sprayed or otherwise deposited on the first upper surface 58. The metalized coating on the first upper surface 58 may provide a reflectivity of at least about 80%. In some embodiments, the first upper surface 58 of the first cut-off portion 54 may be polished to a reflective finish.

The first shield assembly 50 also includes a pair of mounting tabs 70 each extending outwardly from and perpendicularly to a corresponding one of the two first light blockers 52. Each of the mounting tabs 70 includes a first mounting hole 72 for receiving a fastener, such as a screw or a bolt for holding the corresponding mounting tab 70 flush against the first PCB 60. One of the mounting tabs 70 includes a second hole 74 and another one of the mounting tabs 70 includes a slot 76. The second hole 74 and the slot 76 may each function to hold and align the first primary lens assembly 68 together with the first shield assembly 50 in a fixed position within the first housing 32.

The first shield assembly 50 includes a pair of stiffening ribs 80 that may be bent or otherwise formed in the two first light blockers 52 and extending horizontally therealong. The first shield assembly 50 also includes dimples 82 within each of the bends to provide structural rigidity. The dimples 82 are provided in the bends between each of the mounting tabs 70 and the corresponding first light blockers 52 and in the bends between each of the first light blockers 52 and the first cut-off portion 54.

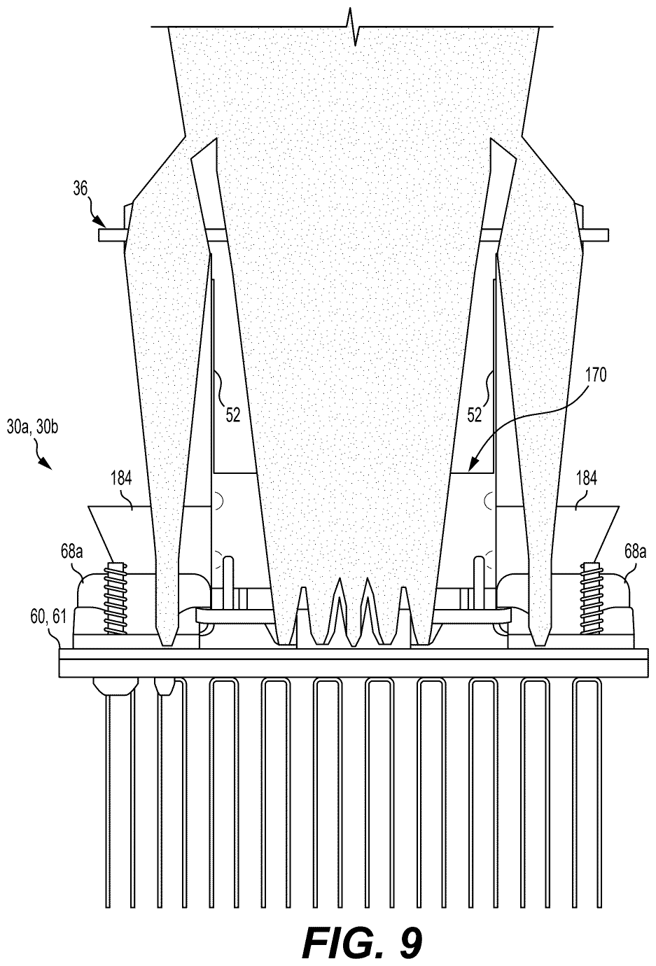

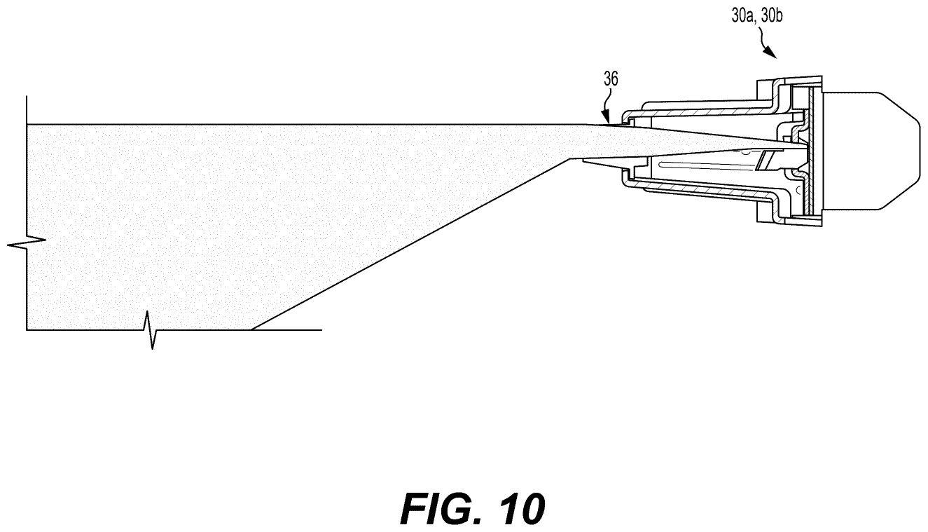

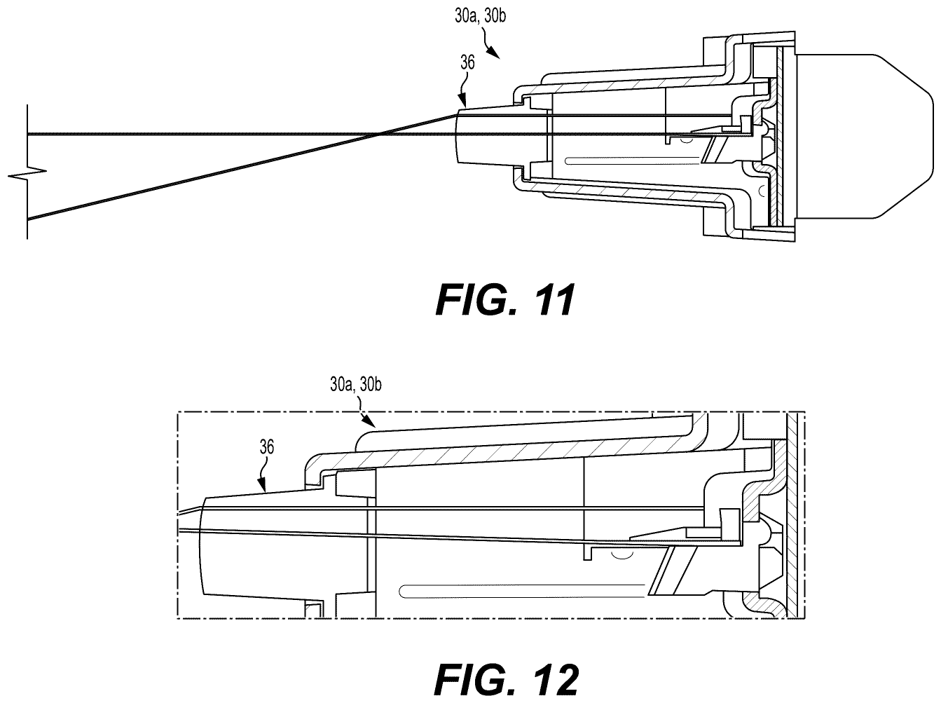

FIGS. 9-10 each show a different view of the lighting module of FIG. 2 and illustrating illumination patterns produced thereby. FIG. 11 shows a cutaway side view of one of the dual-projector lighting modules 30a, 30b of FIG. 2 and illustrating illumination patterns produced by the second light source 34b, as inverted by the first secondary lens 36. FIG. 14 shows a cutaway side view of a dual-projector lighting module 30a, 30b and illustrating an illumination pattern produced by the second light source 34b, and as impacted by a reflective finish on an first upper surface 58 of the first shield assembly 50.

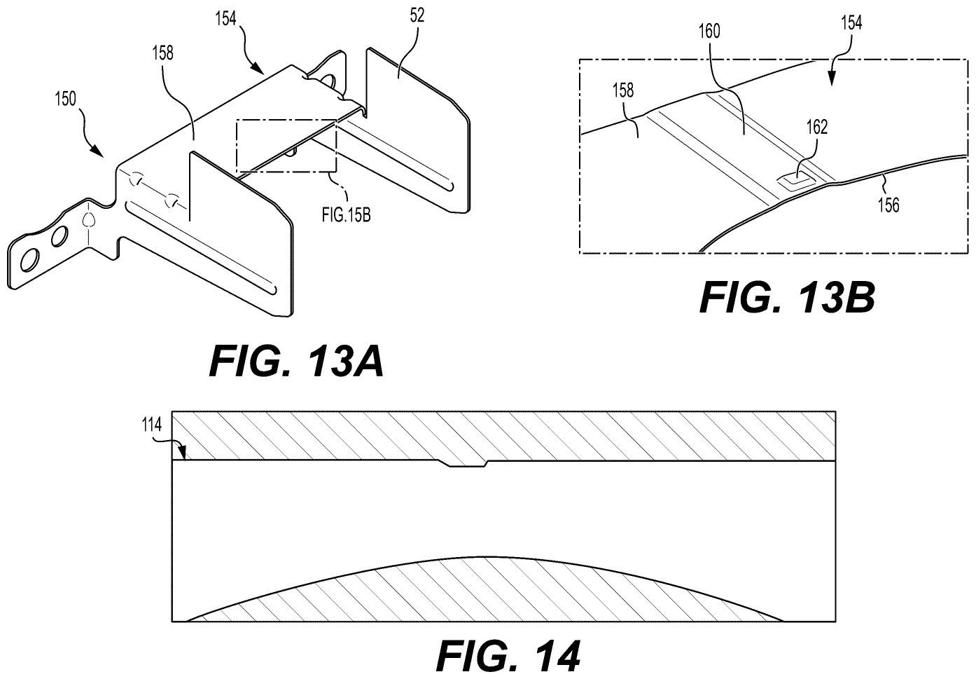

FIGS. 13A-13B show a second shield assembly 150 having second cut-off portion 154 with a second terminal edge 156 that is contoured to generate a specific cut-off pattern 114. The second terminal edge 156 of the second cut-off portion 154 is opposite from the light sources 34a, 34b, 34c, 34d and defines the edge of the cut-off pattern 114. The second cut-off portion 154 includes a second upper surface 158 having a reflective finish and with a ridge 160 that extends along a length thereof, perpendicular to the second terminal edge 156 and protruding upwardly therefrom. The second upper surface 158 of the second cut-off portion 154 also defines a bump 162 that protrudes upwardly therefrom. Either or both of the ridge 160 and/or the bump 162 may define one or more features of the cut-off pattern 114. For example, the ridge 160 and/or the bump 162 may define a blocking portion to shield oncoming traffic from bright light produced by the second light source 34b.

FIG. 14 shows a low beam illumination pattern with the specific cut-off pattern 114 generated by the second shield assembly 150 of FIGS. 13A-13B.

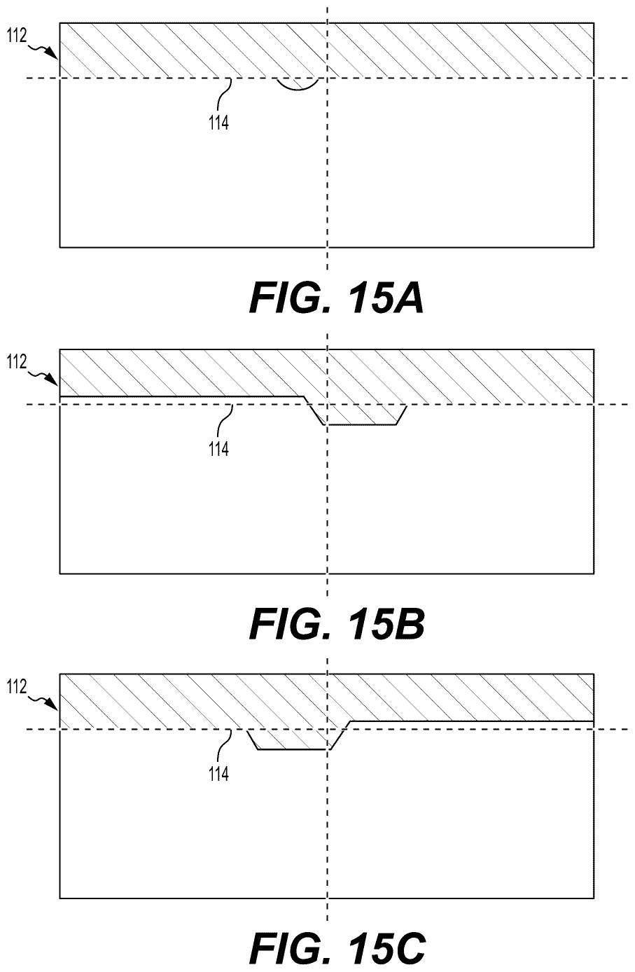

FIGS. 15A-15C show various different cut-off patterns 114 provided by the spot-beam illumination pattern 112 for different regulations and standards for headlight illumination, and which may be generated by the dual-projector lighting modules 30a, 30b of the present disclosure. FIG. 15A shows an example of the cut-off pattern 114 that is formed in accordance with SAE standards for North America. FIG. 15B shows an example of the cut-off pattern 114 that is formed in accordance with ECE standards for Europe and with a left-hand drive (LHD) configuration. FIG. 15C shows an example of the cut-off pattern 114 that is formed in accordance with ECE standards for Europe and with a right-hand drive (RHD) configuration.

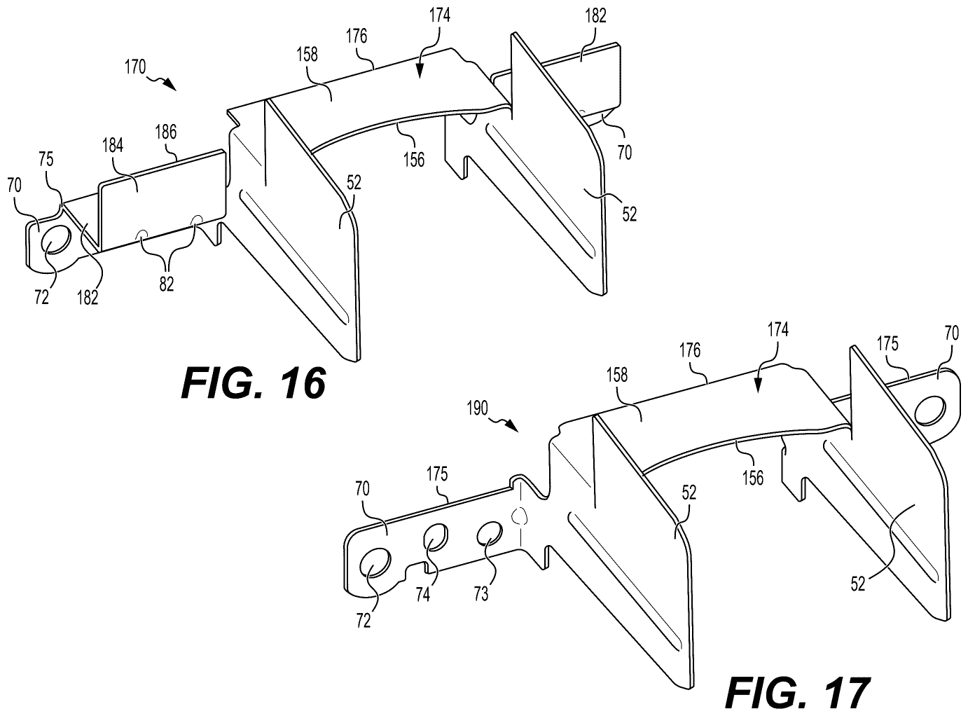

FIG. 16 shows a third shield assembly 170 for installation in a first dual-projector lighting module 30a of the present disclosure. The third shield assembly 170 may be similar or identical to the second shield assembly 150 of FIGS. 13A-13B, except for a few differences described herein. The third shield assembly 170 also includes mounting tabs 70, which each define an upper edge 75. In some embodiments, and as shown in FIG. 17, one or more of the mounting tabs 70 of the third shield assembly 170 may also define a third hole 73, in addition to the first mounting hole 72 and the second hole 74. A projection tab 182 extends from the upper edge 75 of each of the mounting tabs 70 and perpendicular to the mounting tabs 70. A first low-beam (LB) spread shield 184 extends upwardly from each of the projection tabs 182 to an upper edge 186 to define an upper edge of the lighting pattern from corresponding ones of the low-beam projector light sources 34a. The first LB spread shields 184 extend parallel to and spaced apart from each of the mounting tabs 70. The third shield assembly 170 also includes dimples 82 within a bend between each of the projection tabs 182 and a corresponding LB spread shield 184 to provide structural rigidity.

The third shield assembly 170 also includes a third cut-off portion 174, which may be similar or identical to the second cut-off portion 154 of the second shield assembly 150, except the third cut-off portion 174 includes a first ledge 176 that drops down from the plane of the second upper surface 158 thereof, away from the second terminal edge 156. The first ledge 176 may be configured to extend between the second light source 34b and the third light source 34c for isolating light from each of those sources.

FIG. 17 shows a fourth shield assembly 190 for installation in a second dual-projector lighting module 30b of the present disclosure. The fourth shield assembly 190 may be similar or identical to the second shield assembly 150 of FIGS. 13A-13B and/or the third shield assembly 170 of FIG. 16, except for a few differences described herein. The fourth shield assembly 190 does not include any projection tab 182 or LB spread shields 184. Instead, each of the mounting tabs 70 is generally planar and defines a straight horizontal upper edge 175.

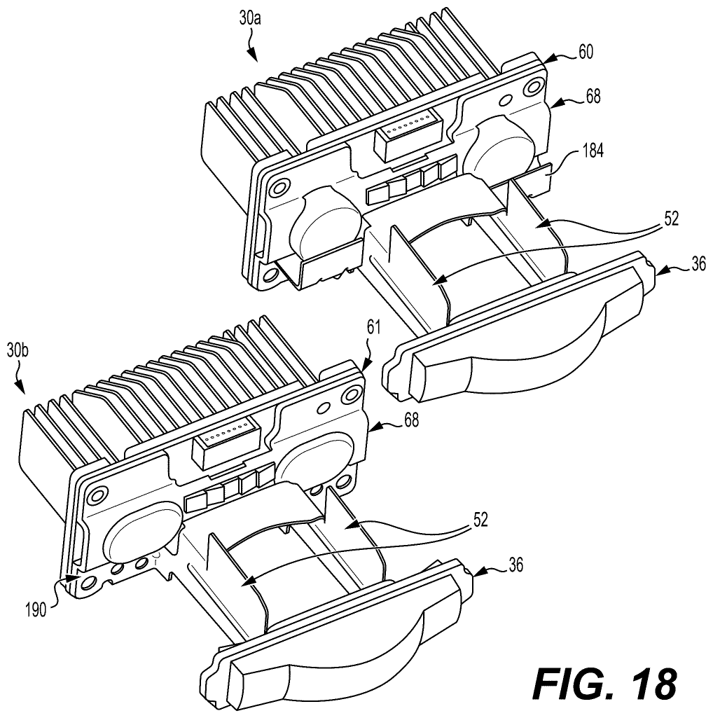

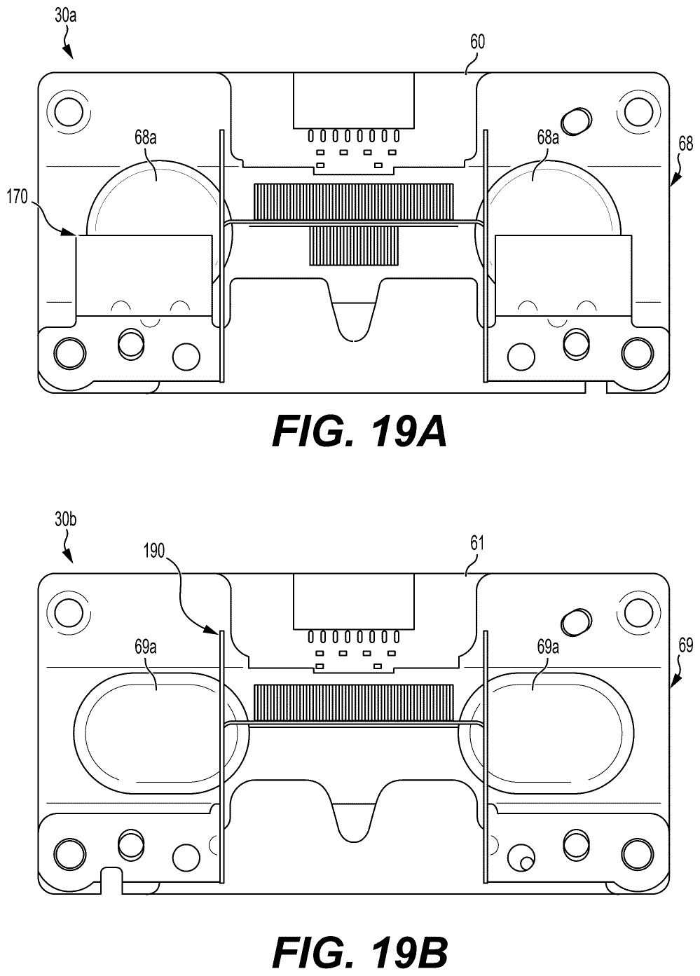

FIG. 18 shows a partial transparent view of the two dual-projector lighting modules 30a, 30b, with the third shield assembly 170 and the fourth shield assembly 190. FIGS. 19A-19B each show a front view of components in the first and second dual-projector lighting modules of the present disclosure, respectively. FIG. 19A shows the first dual-projector lighting module 30a with the first primary lens assembly 68, as shown on FIG. 3, and with the two first primary optic portions 68a each having a round shape, as viewed from the front. FIG. 19B shows the second dual-projector lighting module 30b with a second primary lens assembly 69 in place of the first primary lens assembly 68. The second primary lens assembly 69 includes two fourth primary optic portions 69a in place of the two first primary optic portions 68a of the first primary lens assembly 68. The fourth primary optic portions 69a of the second primary lens assembly 69 each have an oval or racetrack shape that is wider than it is tall, with flat top and bottom edges and rounded ends.

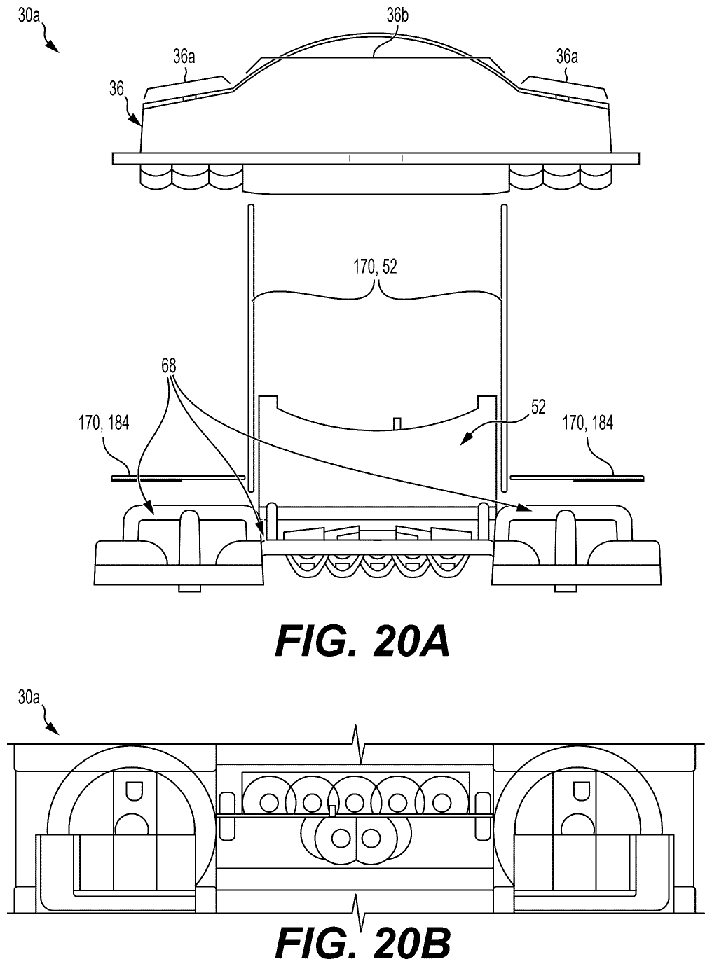

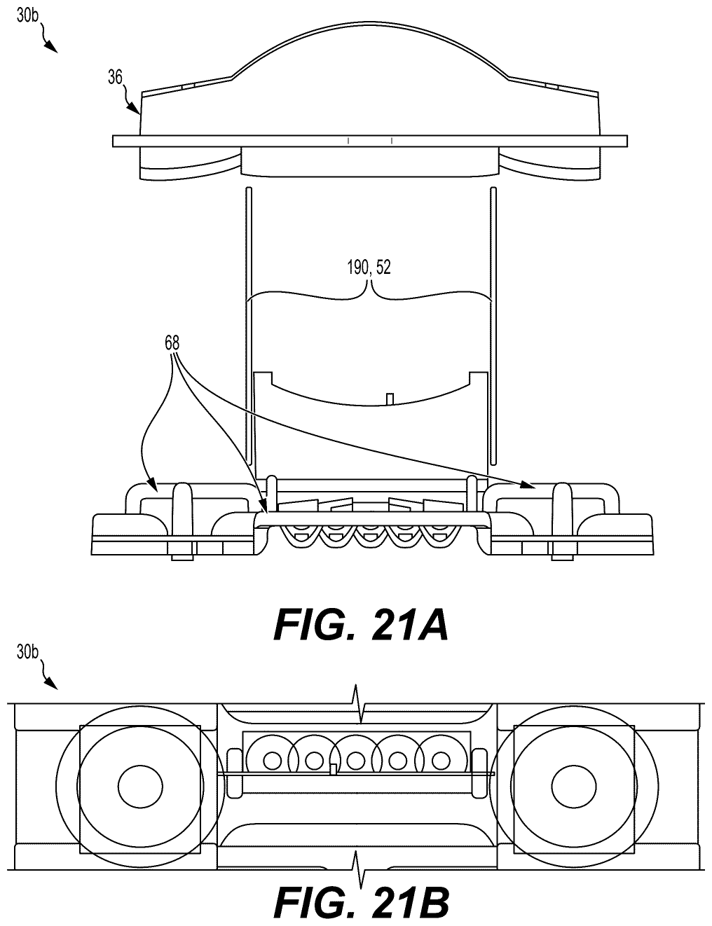

FIGS. 20A-20B show top and front views of components in the first dual-projector lighting module 30a. FIGS. 21A-21B show top and front views of components in the second dual-projector lighting module 30b.

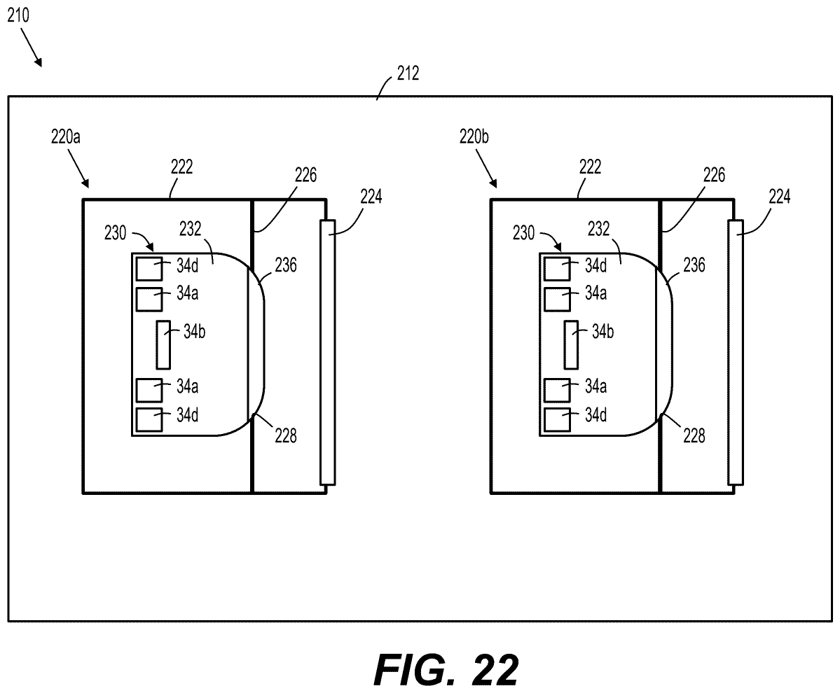

FIG. 22 shows a schematic block diagram of a vehicle 210 with a second lighting system 212, according to an aspect of the present disclosure. The vehicle 210 may be a motor vehicle, such as a passenger car or truck. However, the lighting systems of the present disclosure may be applicable to other types of vehicles, such as commercial trucks, busses, trains, etc. The vehicle 210 with the second lighting system 212 of the present disclosure may also be referred to as the ego vehicle or the subject vehicle. The second lighting system 212 includes a second left-side headlight assembly 220a and a second right-side headlight assembly 220b. Each of the second headlight assemblies 220a, 220b may be similar or identical to one-another. In some embodiments, the second headlight assemblies 220a, 220b may include similar or identical internal components and different external components, such as a second enclosure 222 that is configured to fit within the structure on the corresponding side of the vehicle 210.

As shown in FIG. 22, each of the second headlight assemblies 220a, 220b also includes a second window 224 of transparent material for emitting light and a second bezel 226 disposed within a corresponding one of the second enclosures 222. Each of the second bezels 226 defines a second opening 228. Each of the each of the second headlight assemblies 220a, 220b also includes a single-projector lighting module 230. The single-projector lighting module 230 is configured to provide both high-beam (HB) and low-beam (LB) illumination.

In some embodiments, and as described in the present disclosure, each of the single-projector lighting modules 230 includes four projector light sources 34a, 34d, and a second light source 34b, each configured to produce light. Each of the light sources 34a, 34b, 34d may include one or more light emitting diodes (LEDs) disposed on a substrate, such as a printed circuit board. However, the light sources 34a, 34b, 34d may include other types of illumination sources, such as LED arrays, organic LEDs (OLEDs) halogen bulbs, high-intensity discharge (HID) lamps, lasers, etc. The four projector light sources 34a, 34d include two low-beam projector light sources 34a that are associated with the low-beam function, and two high-beam projector light sources 34d that are associated with the high-beam function. The two high-beam projector light sources 34d may be located on outboard sides of the single-projector lighting module 230, with the two low-beam projector light sources 34a, and the second light source 34b located therebetween. The two low-beam projector light sources 34a may be located inboard of and adjacent to corresponding ones of the high-beam projector light sources 34d, with the second light source 34b located between the two low-beam projector light sources 34a.

Each of the single-projector lighting modules 230 also includes a second secondary lens 236, for focusing and directing light emitted by the corresponding light sources 34a, 34b, 34d. The second secondary lens 236 may be made of polycarbonate (PC) or Poly(methyl methacrylate) (PMMA). However, the second secondary lens 236 may include one or more other materials. In some embodiments, and as shown in FIG. 22, the second secondary lenses 236 may each protrude through a corresponding one of the second openings 228 in the second bezels 226. Each of the single-projector lighting modules 230 also includes a second housing 232. The second housings 232 may be made of a high-temperature polycarbonate (PC-HT) material or a standard temperature (not high-temperature) polycarbonate (PC) material. However, the second housings 232 may include one or more other materials. The second housings 232 each hold the corresponding light sources 34a, 34b, 34d and the corresponding second secondary lens 236, with the second secondary lens 236 at a fixed position relative to the light sources 34a, 34b, 34d and spaced apart therefrom.

The single-projector lighting modules 230 may be arranged in the second headlight assemblies 220a, 220b in a horizontal line. However, the single-projector lighting modules 230 may be vertically oriented or in any other orientation or arrangement. Each of the two single-projector lighting module 230 have second secondary lenses 236 that are generally rectangular, as viewed head-on. The second secondary lenses 236 may have a relatively thin profile. For example, in some embodiments, the second secondary lenses 236 may each have a height of about 15 mm and a width of about 120 mm.

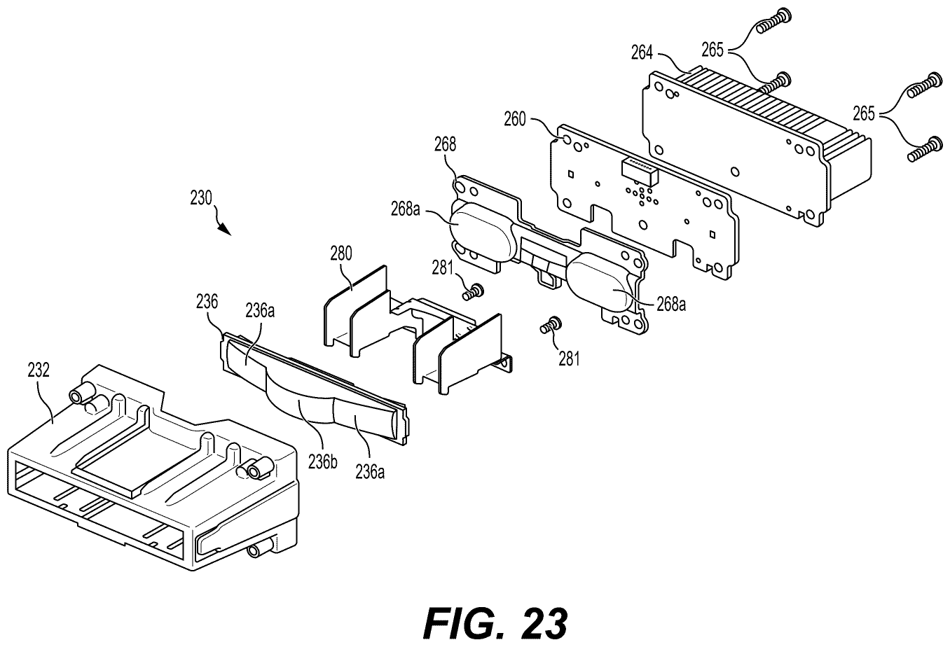

FIG. 23 shows an exploded view of the single-projector lighting module 230. As shown, the single-projector lighting module 230 includes a third PCB 260. The third PCB 260 may hold a plurality of light generating devices, such as LEDs (not shown on FIGS. 20-21) to implement the the light sources 34a, 34b, 34d. A second heat sink 264 is attached to a rear surface of the third PCB 260, opposite from the LEDs.

As shown, the single-projector lighting module 230 includes the second housing 232, the second secondary lens 236, and a fourth shield assembly 280. Two first screws 281 extend through holes in the fourth shield assembly 280 for securing the fourth shield assembly 280 to the second housing 232. A third primary lens assembly 268 is disposed over the light sources 34a, 34b, 34d, between the light sources 34a, 34b, 34d, and the second secondary lens 236. The third primary lens assembly 268 may be made of polycarbonate (PC) or Polymethacrylmethylimide (PMMI). However, the third primary lens assembly 268 may include one or more other materials.

The third primary lens assembly 268 may be similar or identical to the first primary lens assembly 68, except larger to accommodate all of the four projector light sources 34a, 34d. The third primary lens assembly 268 includes two second primary optic portions 268a in place of the two first primary optic portions 68a of the first primary lens assembly 68 and which are each disposed in an optical path between two adjacent ones of the projector light sources 34a, 34d and a corresponding lens portion of the second secondary lens 236.

The second secondary lens 236 includes two third lens portions 236a disposed on either side of a fourth lens portion 236b. The two third lens portions 236a may each be aligned with and configured to focus and direct light from a corresponding set of the projector light sources 34a, 34d. The fourth lens portion 236b may be aligned with and configured to focus and direct light from the second light source 34b. A set of four second screws 265 extends through the second heat sink 264, the third PCB 260, and the third primary lens assembly 268 and is fastened into the second housing 232 for securing the components of the single-projector lighting module 230.

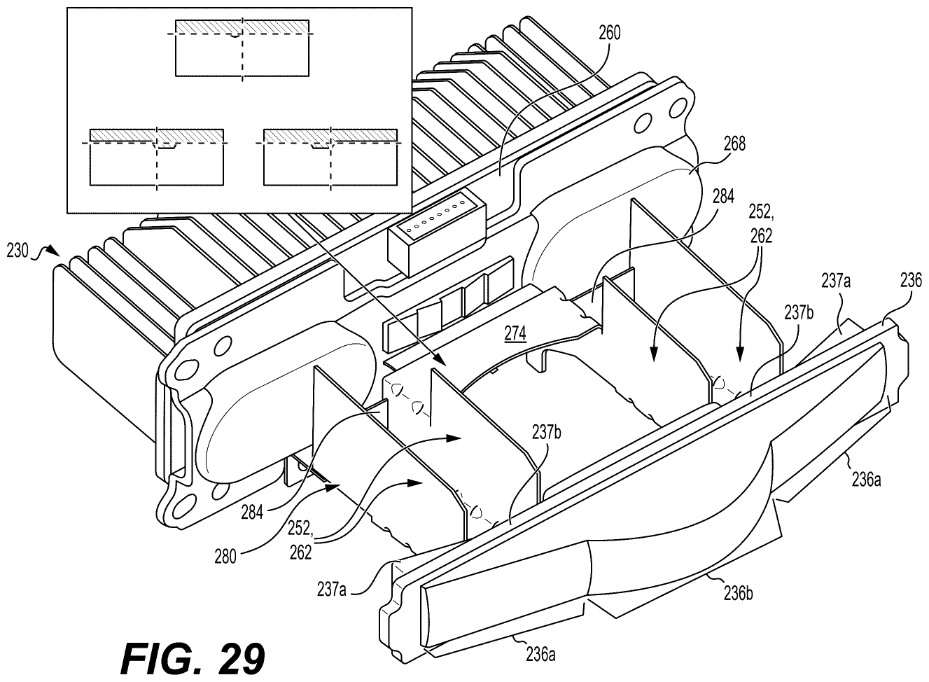

Additionally, and with reference to FIG. 29, each of the two third lens portions 236a may further be divided into a high-beam projector secondary lens 237a, and a low-beam projector secondary lens 237b. The high-beam projector secondary lens 237a is arranged and configured for directing and focusing light from a corresponding one of the high-beam projector light sources 34d, and the low-beam projector secondary lens 237b is arranged and configured for directing and focusing light from a corresponding one of the low-beam projector light sources 34a.

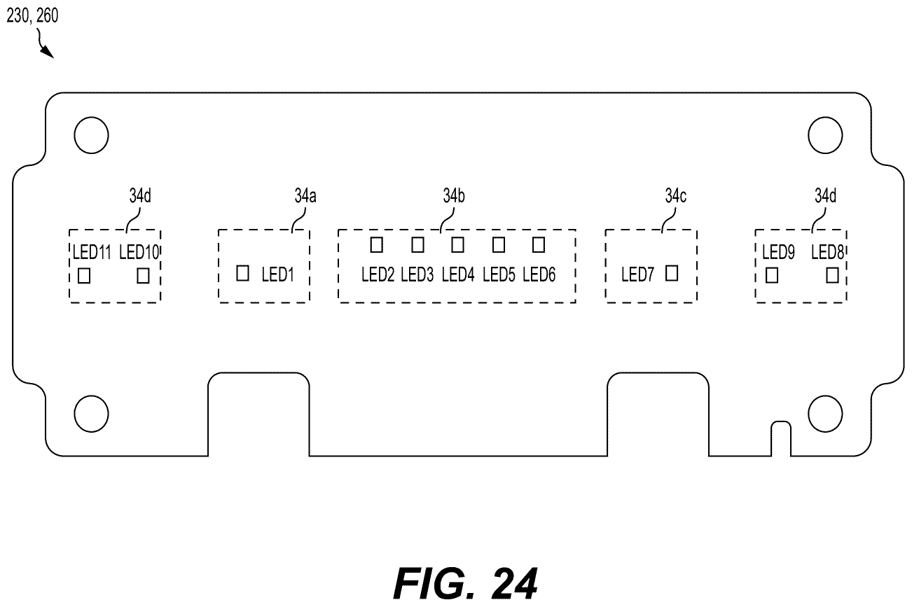

FIG. 24 shows a front view of the third PCB 260 of the single-projector lighting module 230, including LEDs mounted thereon for implementing the light sources 34a, 34b, 34d.

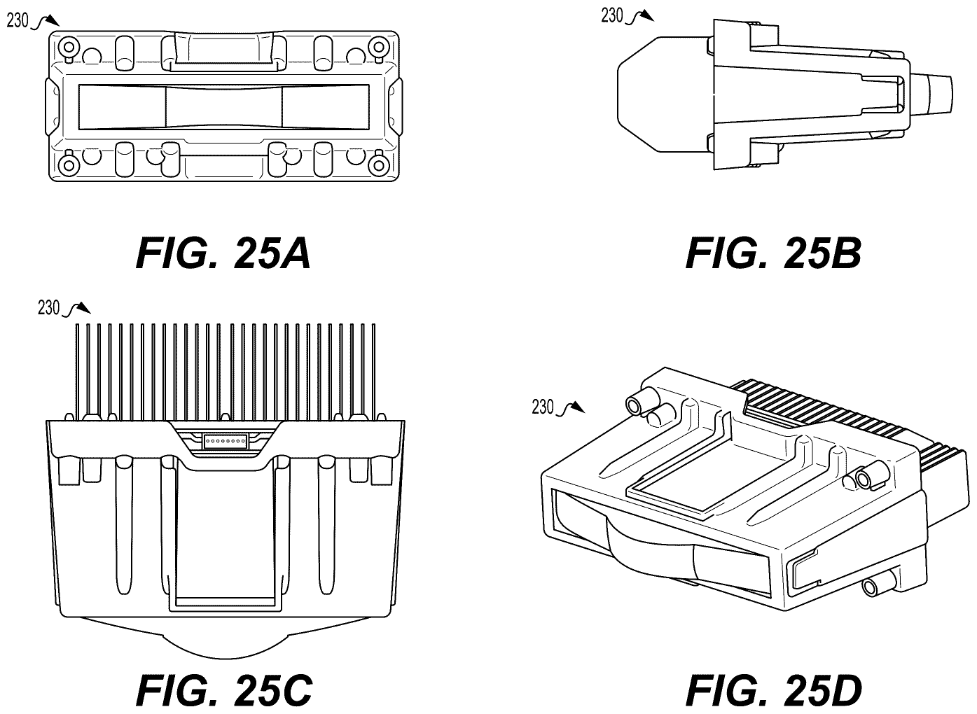

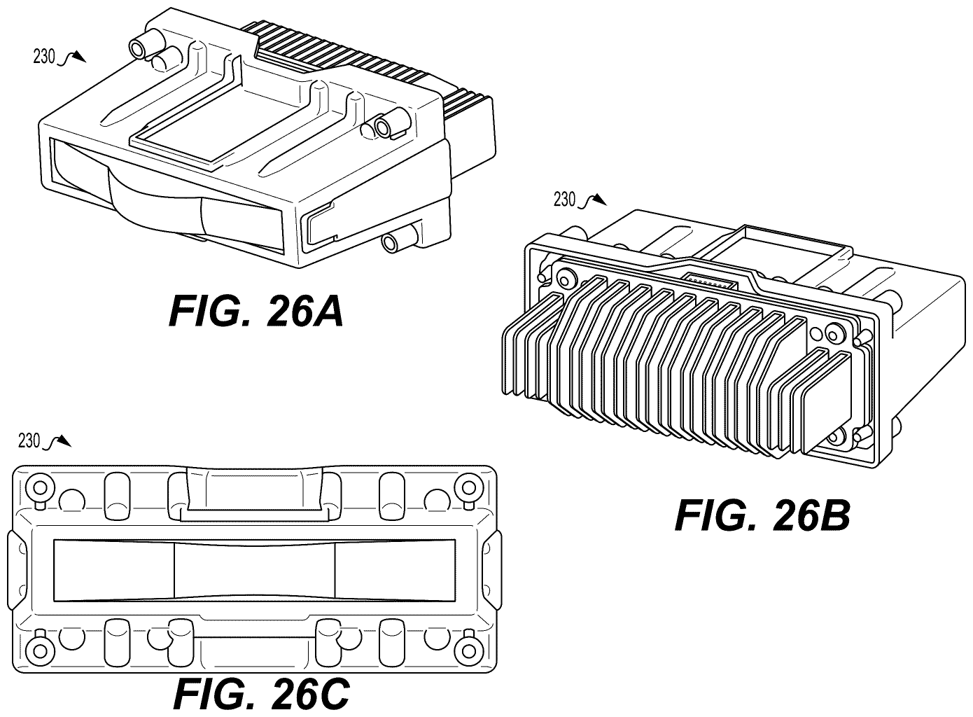

FIGS. 25A-25D show various views of a single-projector lighting module 230. FIGS. 26A-26C show additional views of the single-projector lighting module 230.

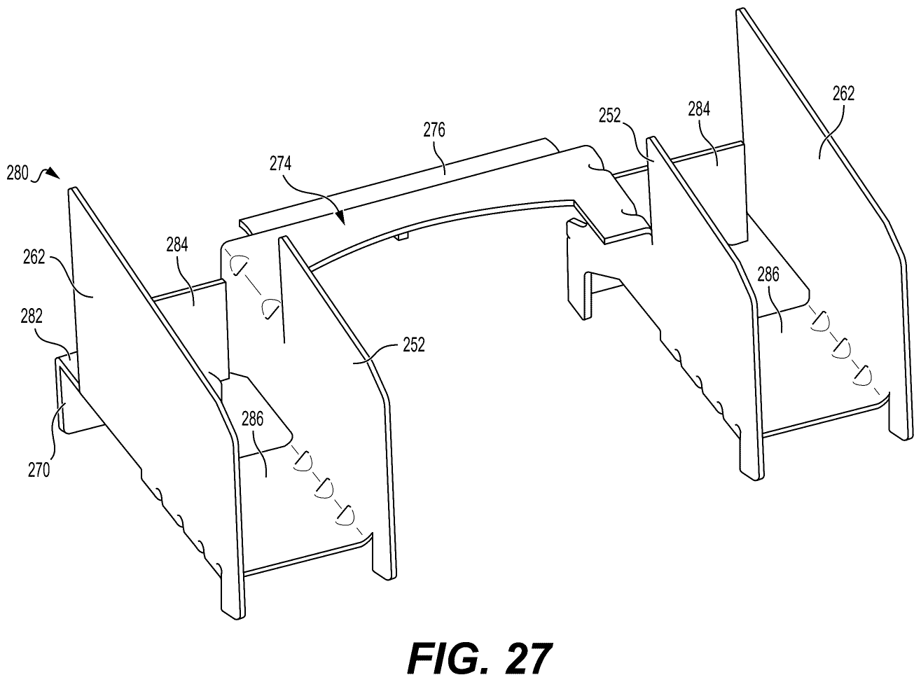

FIG. 27 shows the fourth shield assembly 280 for the single-projector lighting module of the present disclosure. The fourth shield assembly 280 may be similar or identical to the third shield assembly 170, except for differences described herein.

The fourth shield assembly 280 also includes two mounting tabs 270, which may be similar or identical to the mounting tabs 70 of the third shield assembly 170. A second projection tab 282 extends from an upper edge 75 of each of the mounting tabs 270 and perpendicular to the mounting tabs 270. A second low-beam (LB) spread shield 284 extends upwardly from each of the second projection tabs 282 to define an upper edge of the lighting pattern from corresponding ones of the low-beam projector light sources 34a. The second LB spread shields 284 extend parallel to and spaced apart from each of the mounting tabs 270.

The fourth shield assembly 280 also includes a fourth cut-off portion 274, which may be similar or identical to the third cut-off portion 174 of the third shield assembly 170. The fourth shield assembly 280 also includes a second ledge 276 that may be similar or identical to the first ledge 176 of the third shield assembly 170.

The fourth shield assembly 280 also includes two second light blockers 252 that may be similar or identical to the first light blockers 52 of the third shield assembly 170. As shown, the second light blockers 252 are disposed on opposite sides of the fourth cut-off portion 274 and extend perpendicular thereto and are spaced apart and parallel to one-another. Like the first light blockers 52, the second light blockers 252 each extend in a vertical plane and are configured to block light from the projector light sources 34a, 34d from reaching lens portions of the second secondary lens 23 and which are associated with the second light source 34b.

The fourth shield assembly 280 also includes a horizontal support 286 that extends outwardly from each of the second light blockers 252 and perpendicularly thereto. The fourth shield assembly 280 also includes two third light blockers 262 that extend parallel to and spaced apart from the second light blockers 252. The horizontal supports 286 each extend between one the second light blockers 252 and a corresponding one of the third light blockers 262. Like the first light blockers 52, the second light blockers 252 each extend in a vertical plane and are configured to isolate light from the two projector light sources 34a, 34d that are disposed adjacent thereto. Thus, light from each of the projector light sources 34a, 34d may be limited to projecting light through a corresponding high-beam projector secondary lens 237a or low-beam projector secondary lens 237b.

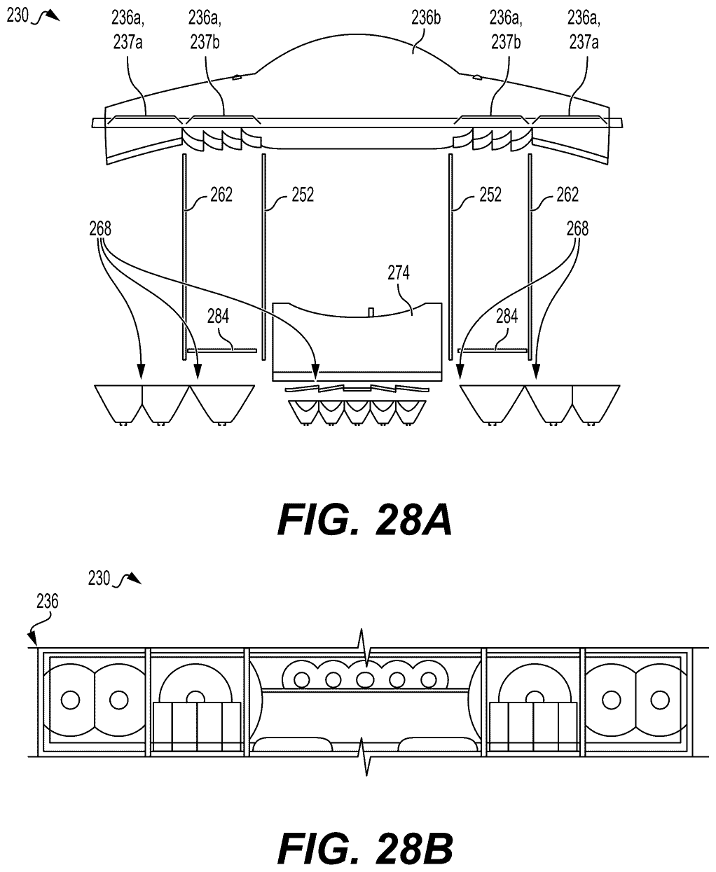

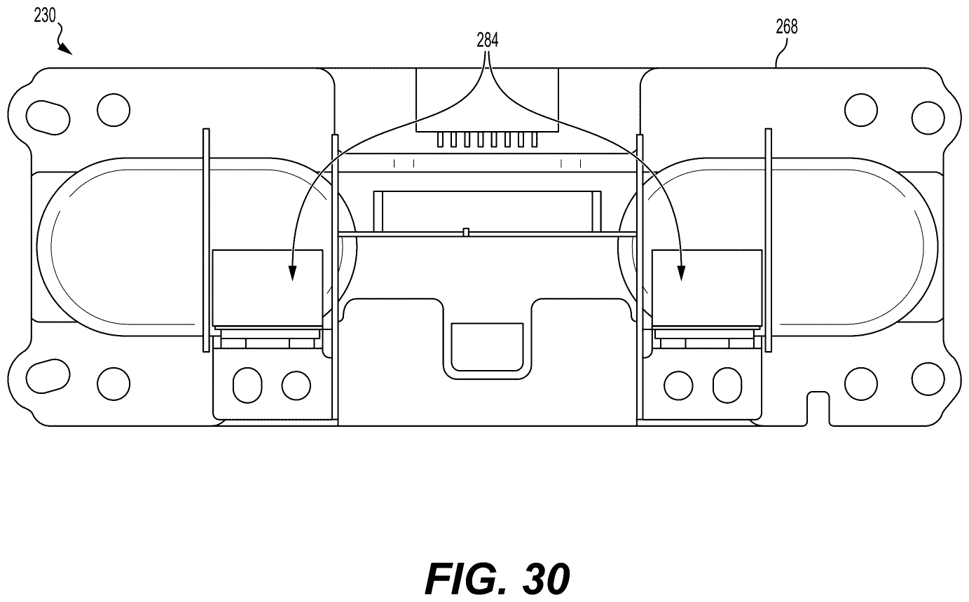

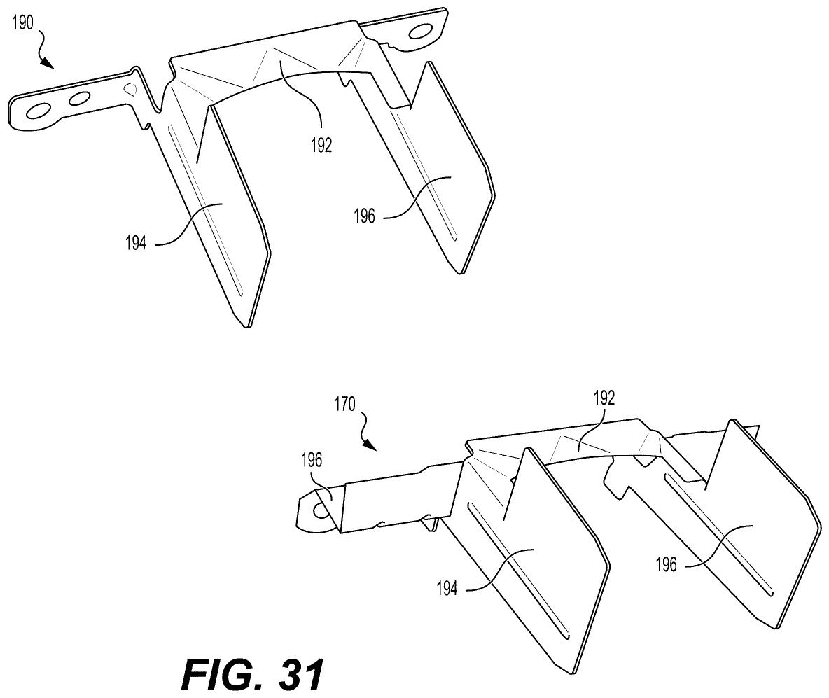

FIGS. 28A-28B show top and front views of components in the single-projector lighting module 230. FIG. 29 shows a perspective view of components in the single-projector lighting module 230. FIG. 30 shows a front view of components in the single-projector lighting module 230. FIG. 31 shows the third shield assembly 170 and the fourth shield assembly 190, with details regarding different finishes applied to surfaces thereof. More specifically, FIG. 31 shows a first mirrored finish 192 applied to upper surfaces of a horizontally-extending center portion. The first mirrored finish 192 may be formed by applying a metallization process to a mirror-polished raw material and may provide a reflectivity that is greater than or equal to 80%. FIG. 31 also shows horizontal shields of the third shield assembly 170 and the fourth shield assembly 190 with outer surfaces having a second mirrored finish 194. The second mirrored finish 194 may be formed by polishing raw sheet metal material, and may provide a reflectivity that is less than or equal to 60%. FIG. 31 also shows the horizontal shields with inner surfaces having a third finish 196. A horizontal outer portion of the third shield assembly 170 also includes the third finish 196. The third finish 196 may be formed keeping the sheet metal material in a raw or unfinished condition, and may provide a reflectivity that is approximately equal to 30%.

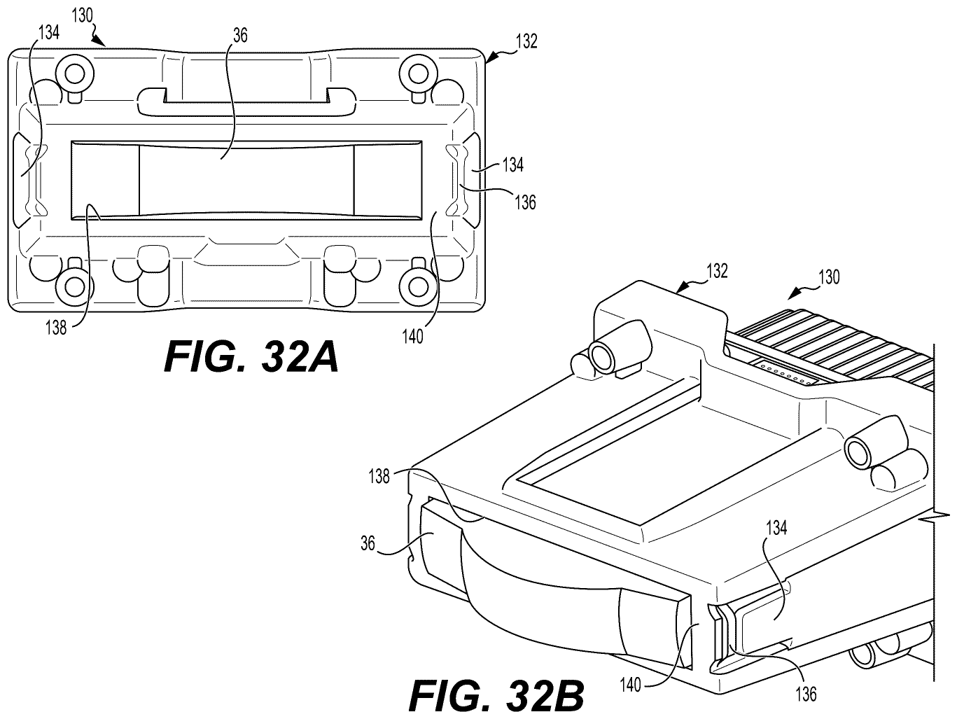

FIGS. 32A-32B show different views of a third lighting module 130 of the present disclosure, with a snap feature for retaining a first secondary lens 36 therein. The snap feature of the third lighting module 130 may be used with the dual-projector lighting modules 30a, 30b and/or with the single-projector lighting module 230 of the present disclosure. However, the snap feature shown in FIGS. 32A-32B may be used with other lighting modules. The third lighting module 130 includes a third housing 132 that may be similar or identical to the first housing 32 of the dual-projector lighting modules 30a, 30b.

The third housing 132 has a tubular shape with a generally rectangular cross-section and which extends defines a first end 140 that faces outward, and which defines an A-surface that is visible to an outside observer through a window 24, 224 of a headlight assembly. The first end 140 end defines a second aperture 138 having a rectangular shape. The first secondary lenses 36 are each disposed within a corresponding one of the third housing 132, adjacent to the first end 140 and protruding through the second aperture 138. The first secondary lenses 36 may be installed from a back side of the first end 140 (i.e. an interior of the third housing) and may be retained against a back surface, opposite of the A-surface. The back surface, inside the third housing 132, may be called a B-surface and may not be visible when the third housing 132 is installed in a vehicle.

As shown, the third housing 132 also includes two retaining tabs 134 defined on side walls of the third housing 132 and which are configured to retain the first secondary lenses 36 in position against the first end 140. The retaining tabs 134 may be integrally molded with the third housing 132. However, the retaining tabs 134 may be otherwise affixed to the third housing 132. The retaining tabs 134 may be configured to flex outwardly when the first secondary lenses 36 are installed and to snap inwardly to engage and hold an ear 136 of the first secondary lenses 36 which extends outwardly from each side thereof. As shown on FIG. 32B, the ears 136 of the first secondary lenses 36 may protrude through a hole in the side of the third housing 132 and be retained between a free end of a corresponding one of the retaining tabs 134 and the back surface of the third housing 132 at the first end 140 and opposite of the A-surface.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lighting module for a headlight in a vehicle, comprising:
a projector light source;
a second light source associated with a low-beam function;
a lens defining a first lens portion associated with the projector light source and a second lens portion associated with the second light source;
a housing holding the projector light source and the second light source and holding the lens at a fixed position relative to the projector light source and the second light source and spaced apart therefrom; and
a shield assembly disposed in an interior of the housing between the light sources and the lens and including a light blocker configured to block light from the projector light source from reaching the second lens portion and to block light from the second light source from reaching the first lens portion, and
wherein the shield assembly further includes a cut-off portion configured to interrupt a portion of light emitted from the second light source and to define a cut-off pattern.

2. The lighting module of claim 1, wherein the cut-off portion extends in a horizontal plane.

3. The lighting module of claim 2, wherein the cut-off portion defines a terminal edge opposite from the second light source, and wherein the terminal edge defines the cut-off pattern.

4. The lighting module of claim 2, wherein the cut-off portion defines an upper surface having a reflective finish.

5. The lighting module of claim 4, wherein the upper surface of the cut-off portion includes a metalized coating.

6. The lighting module of claim 1, wherein the lighting module includes two of the projector light sources, wherein the second light source is disposed between the two of the projector light sources, and
wherein the light blocker includes two light blockers, with each of the two light blockers configured to block light from a corresponding projector light source of the projector light sources.

7. The lighting module of claim 1, wherein the light blocker extends in a vertical plane.

8. The lighting module of claim 1, wherein the light blocker extends in a first plane and wherein the cut-off portion extends in a second plane perpendicular to the first plane.

9. The lighting module of claim 1, wherein the shield assembly includes a piece of sheet metal that is bent to define each of the light blocker and the cut-off portion.

10. The lighting module of claim 1, further including a third light source, and
wherein the third light source is disposed on a side of the cut-off portion opposite from the second light source.

11. The lighting module of claim 10, wherein the third light source is associated with a high-beam function.

12. The lighting module of claim 1, further including a primary lens assembly disposed in an optical path between at least one of the projector light source or the second light source, and the lens.

13. The lighting module of claim 12, wherein the primary lens assembly includes a first primary optic portion disposed in a first optical path between the projector light source and the lens, and a second primary optic portion disposed in a second optical path between the second light source and the lens.

14. The lighting module of claim 1, wherein the lighting module includes four of the projector light sources, wherein the second light source is disposed between two projector light sources of the projector light sources.

15. The lighting module of claim 14, wherein the light blocker includes four light blockers, with each of the four light blockers configured to block light from a corresponding projector light source of the projector light sources.

16. The lighting module of claim 1, wherein the housing further defines an aperture and one or more retaining tabs configured to hold the lens against an interior surface of the housing and in a fixed position extending through the aperture.

17. A lighting module for a headlight in a vehicle, comprising:
a projector light source;
a second light source associated with a low-beam function;
a lens defining a first lens portion associated with the projector light source and a second lens portion associated with the second light source; and
a housing holding the projector light source and the second light source and holding the lens at a fixed position relative to the projector light source and the second light source and spaced apart therefrom, wherein the housing further defines an aperture and one or more retaining tabs configured to hold the lens against an interior surface of the housing and in a fixed position extending through the aperture.

18. A headlight assembly for a vehicle, comprising two of the lighting modules of claim 1,
wherein the projector light source of one of the two lighting modules is associated with the low-beam function, and wherein the projector light source of another one of the two lighting modules is associated with a high-beam function.

19. A lighting system for a vehicle, comprising:
two headlight assemblies, with each of the headlight assemblies including at least one lighting module, with each lighting module of the at least one lighting module including:
a projector light source;
a second light source associated with a low-beam function;
a lens defining a first lens portion associated with the projector light source and a second lens portion associated with the second light source;
a housing holding the projector light source and the second light source and holding the lens at a fixed position relative to the projector light source and the second light source and spaced apart therefrom; and
a shield assembly disposed in an interior of the housing between the light sources and the lens and including a light blocker configured to block light from the projector light source from reaching the second lens portion and to block light from the second light source from reaching the first lens portion,
wherein the shield assembly further includes a cut-off portion configured to interrupt a portion of light emitted from the second light source and to define a cut-off pattern.

20. The lighting system of claim 19, wherein the at least one lighting module includes two of the lighting modules disposed in each of the two headlight assemblies.
